(19) United States
(12) Patent Application Publication
(10) Pub. No.: US 2013/0100038 A1
(43) Pub. Date: Apr. 25, 2013

(54) Single-Layer Touch Sensor

(71) Applicants: Esat YILMAZ, Santa Cruz, CA (US); Matthew TREND, Fareham (GB)

(72) Inventors: Esat YILMAZ, Santa Cruz, CA (US); Matthew TREND, Fareham (GB)

(73) Assignee: Atmel Technologies U.K. Limited, Fareham (GB)

(21) Appl. No.: 13/278,046

(22) Filed: Oct. 20, 2011

(51) Int. Cl. G06F 3/041; H01H 13/70

(52) U.S. Cl. 345/173; 200/5 A

(57) ABSTRACT

In one embodiment, a touch sensor includes multiple first electrode lines along a first direction. Each of the first electrode lines includes multiple first electrodes. The touch sensor also includes multiple second electrode lines along a second direction substantially perpendicular to the first direction. Each of the second electrode lines includes one second electrode. The second electrode of each of the second electrode lines is interdigitated with one of the first electrodes of each of the first electrode lines. The first and second electrodes are disposed on one side of a substrate.

### TECHNICAL FIELD

This disclosure generally relates to touch sensors.

### BACKGROUND

An array of conductive drive and sense electrodes may form a mutual-capacitance touch sensor having one or more capacitive nodes. The mutual-capacitance touch sensor may have either a two-layer configuration or single-layer configuration. In a single-layer configuration, drive and sense electrodes may be disposed in a pattern on one side of a substrate. In such a configuration, a pair of drive and sense electrodes capacitively coupled to each other across a space or dielectric between electrodes may form a capacitive node.

In a single-layer configuration for a self-capacitance implementation, an array of vertical and horizontal conductive electrodes may be disposed in a pattern on one side of the substrate. Each of the conductive electrodes in the array may form a capacitive node, and, when an object touches or comes within proximity of the electrode, a change in self-capacitance may occur at that capacitive node and a controller may measure the change in capacitance as a change in voltage or a change in the amount of charge needed to raise the voltage to some pre-determined amount.

In a touch-sensitive display application, a touch screen may enable a user to interact directly with what is displayed on a display underneath the touch screen, rather than indirectly with a mouse or touchpad. A touch screen may be attached to or provided as part of, for example, a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch screen.

### BRIEF DESCRIPTION OF THE DRAWINGS

FIG. 1 illustrates an example touch sensor with an example controller.

FIG. 2 illustrates an example pattern for an example single-layer touch sensor.

FIG. 3 illustrates another example pattern for an example single-layer touch sensor.

FIG. 4 illustrates another example pattern for an example single-layer touch sensor.

FIG. 5 illustrates another example pattern for an example single-layer touch sensor.

FIG. 6 illustrates another example pattern for an example single-layer touch sensor.

### DESCRIPTION OF EXAMPLE EMBODIMENTS

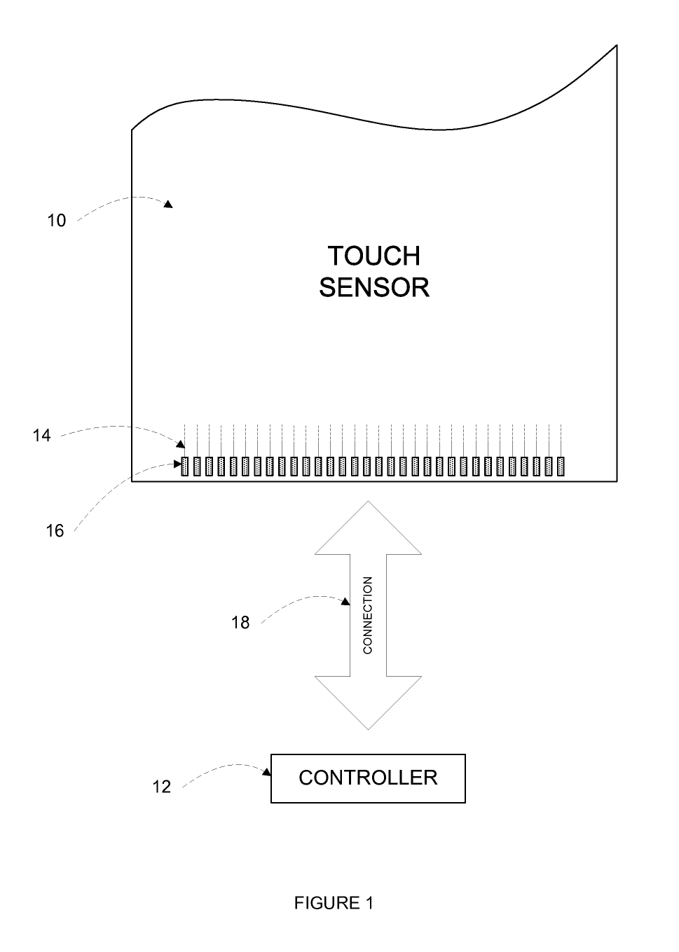

FIG. 1 illustrates an example touch sensor 10 with an example controller 12. Herein, reference to a touch sensor may encompass a touch screen, and vice versa, where appropriate. Touch sensor 10 and controller 12 may detect the presence and location of a touch or the proximity of an object within a touch-sensitive area of touch sensor 10. Herein, reference to a touch sensor may encompass both the touch sensor and its controller, where appropriate. Similarly, reference to a controller may encompass both the controller and its touch sensor, where appropriate. Touch sensor 10 may include one or more touch-sensitive areas, where appropriate. Touch sensor 10 may include an array of drive and sense electrodes disposed on a substrate, which may be a dielectric material.

One or more portions of the substrate of touch sensor 10 may be made of polyethylene terephthalate (PET) or another suitable material. This disclosure contemplates any suitable substrate with any suitable portions made of any suitable material. In particular embodiments, the drive or sense electrodes in touch sensor 10 may be made of indium tin oxide (ITO) in whole or in part. In particular embodiments, the drive or sense electrodes in touch sensor 10 may be made of a mesh of fine lines of metal or other conductive material. As an example and not by way of limitation, the fine lines of conductive material may be copper or copper-based and have a thickness of approximately 5 μm or less and a width of approximately 10 μm or less. As another example, the fine lines of conductive material may be silver or silver-based and similarly have a thickness of approximately 5 μm or less and a width of approximately 10 μm or less. This disclosure contemplates any suitable electrodes made of any suitable material.

Touch sensor 10 may implement a capacitive form of touch sensing. In a mutual-capacitance implementation, touch sensor 10 may include an array of drive and sense electrodes forming an array of capacitive nodes. A drive electrode and a sense electrode may form a capacitive node. The drive and sense electrodes forming the capacitive node may come near each other, but not make electrical contact with each other. Instead, the drive and sense electrodes may be capacitively coupled to each other across a gap between them. A pulsed or alternating voltage applied to the drive electrode (by controller 12) may induce a charge on the sense electrode, and the amount of charge induced may be susceptible to external influence (such as a touch or the proximity of an object). When an object touches or comes within proximity of the capacitive node, a change in capacitance may occur at the capacitive node and controller 12 may measure the change in capacitance. By measuring changes in capacitance throughout the array, controller 12 may determine the position of the touch or proximity within the touch-sensitive area(s) of touch sensor 10.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, where appropriate. Similarly, reference to a sense line may encompass one or more sense electrodes making up the sense line, and vice versa, where appropriate.

Touch sensor 10 may have a single-layer configuration and mutual-capacitance implementation with drive and sense electrodes disposed in a pattern on one side of a substrate. In such a configuration, a pair of drive and sense electrodes capacitively coupled to each other across a space between them to form a capacitive node. In a single-layer configuration for a self-capacitance implementation, electrodes may be disposed in a pattern on one side of the substrate. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at a capacitive node of touch sensor 10 may indicate a touch or proximity input at the position of the capacitive node. Controller 12 may detect and process the change in capacitance to determine the presence and location of the touch or proximity input. Controller 12 may then communicate information about the touch or proximity input to one or more other components (such one or more central processing units (CPUs) or digital signal processors (DSPs)) of a device that includes touch sensor 10 and controller 12, which may respond to the touch or proximity input by initiating a function of the device (or an application running on the device) associated with it. Although this disclosure describes a particular controller having particular functionality with respect to a particular device and a particular touch sensor, this disclosure contemplates any suitable controller having any suitable functionality with respect to any suitable device and any suitable touch sensor.

Controller 12 may be one or more integrated circuits (ICs)—such as for example general-purpose microprocessors, microcontrollers, programmable logic devices or arrays, application-specific ICs (ASICs) and may be on a flexible printed circuit (FPC) bonded to the substrate of touch sensor 10, as described below. Controller 12 may include a processor unit, a drive unit, a sense unit, and a storage unit. The drive unit may supply drive signals to the drive electrodes of touch sensor 10. The sense unit may sense charge at the capacitive nodes of touch sensor 10 and provide measurement signals to the processor unit representing capacitances at the capacitive nodes. The processor unit may control the supply of drive signals to the drive electrodes by the drive unit and process measurement signals from the sense unit to detect and process the presence and location of a touch or proximity input within the touch-sensitive area(s) of touch sensor 10. The processor unit may also track changes in the position of a touch or proximity input within the touch-sensitive area(s) of touch sensor 10. The storage unit may store programming for execution by the processor unit, including programming for controlling the drive unit to supply drive signals to the drive electrodes, programming for processing measurement signals from the sense unit, and other suitable programming, where appropriate. Although this disclosure describes a particular controller having a particular implementation with particular components, this disclosure contemplates any suitable controller having any suitable implementation with any suitable components.

Tracks 14 of conductive material disposed on the substrate of touch sensor 10 may couple the drive or sense electrodes of touch sensor 10 to bond pads 16, also disposed on the substrate of touch sensor 10. As described below, bond pads 16 facilitate coupling of tracks 14 to controller 12. Tracks 14 may extend into or around (e.g. at the edges of) the touch-sensitive area(s) of touch sensor 10. Particular tracks 14 may provide drive connections for coupling controller 12 to drive electrodes of touch sensor 10, through which the drive unit of controller 12 may supply drive signals to the drive electrodes. Other tracks 14 may provide sense connections for coupling controller 12 to sense electrodes of touch sensor 10, through which the sense unit of controller 12 may sense charge at the capacitive nodes of touch sensor 10. Tracks 14 may be made of fine lines of metal or other conductive material. As an example and not by way of limitation, the conductive material of tracks 14 may be copper or copper-based and have a width of approximately 100 μm or less. As another example, the conductive material of tracks 14 may be silver or silver-based and have a width of approximately 100 μm or less. In particular embodiments, tracks 14 may be made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 14, touch sensor 10 may include one or more ground lines terminating at a ground connector (similar to a bond pad 16) at an edge of the substrate of touch sensor 10 (similar to tracks 14).

Bond pads 16 may be located along one or more edges of the substrate, outside the touch-sensitive area(s) of touch sensor 10. As described above, controller 12 may be on an FPC. Bond pads 16 may be made of the same material as tracks 14 and may be bonded to the FPC using an anisotropic conductive film (ACF). Connection 18 may include conductive lines on the FPC coupling controller 12 to bond pads 16, in turn coupling controller 12 to tracks 14 and to the drive or sense electrodes of touch sensor 10. This disclosure contemplates any suitable connection 18 between controller 12 and touch sensor 10.

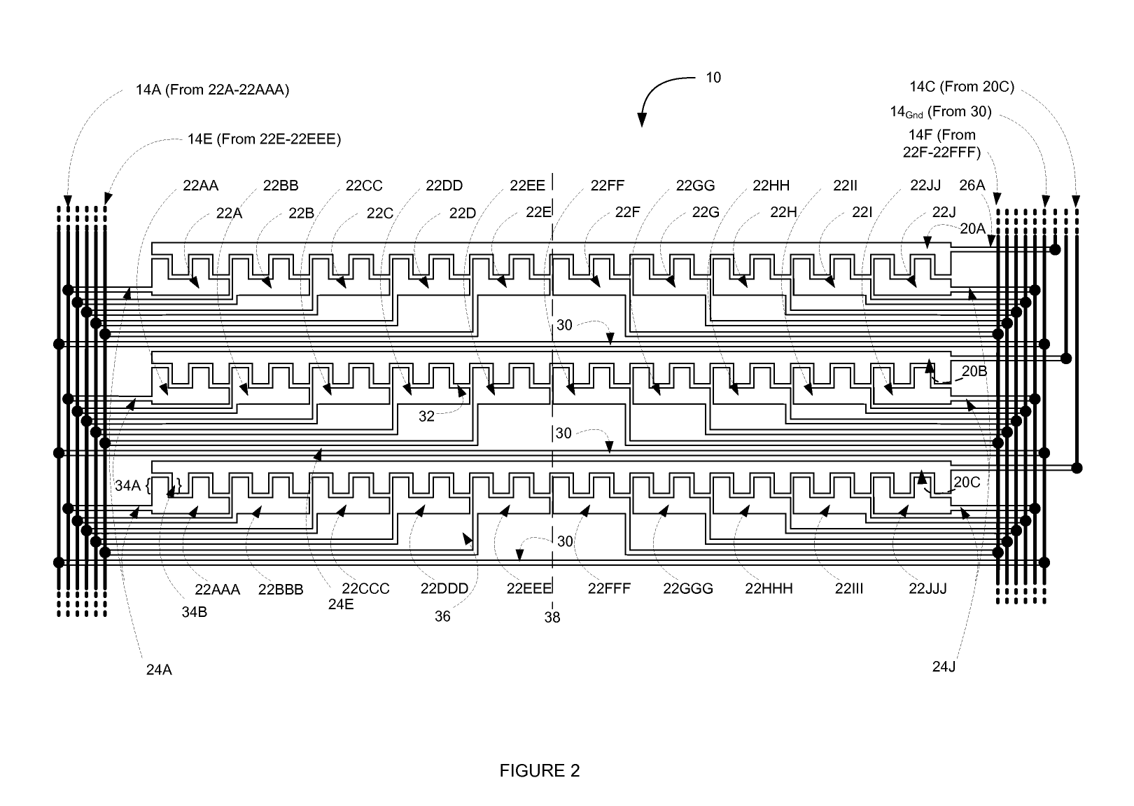

FIG. 2 illustrates an example single-layer touch sensor for use in the example system of FIG. 1. In the example of FIG. 2, touch sensor 10 includes an array of one or more drive electrodes 20A-C and one or more sense electrodes 22A-JJJ defining a touch-sensitive area of touch sensor 10. A row of the array includes a drive electrode 20A-C extending along an axis corresponding to the row of the array. Each row also includes one or more sense electrodes 22A-JJJ disposed in parallel and adjacent to corresponding drive electrode 20A-C. As an example and not by way of limitation, a row of the array includes drive electrode 20A with corresponding sense electrodes 22A-J disposed along an axis parallel to drive electrode 20A. One or more sense electrodes 22A-JJJ commonly coupled to a track, e.g., 14A, 14E, 14C, and 14F may define columns that are substantially perpendicular to rows of the array. As an example and not by way of limitation, sense electrodes 22F-FFF commonly coupled to track 14F may define a column of the array. As discussed above, each drive electrode 20A-C may be capacitively coupled to one or more adjacent sense electrodes 22A-JJJ separated by a gap 32.

A ground shape 30 extends along an axis parallel to rows of the array and separating one or more sense electrodes 22A-JJJ of one row from drive electrode 20A-D of a different row. Ground shape 30 serves to suppress unintentional capacitive coupling between adjacent rows of electrodes or electrode connections and adjacent electrodes. As an example and not by way of limitation, ground shape 30 suppresses capacitive coupling between sense electrodes 22AA-JJ and drive electrode 20C or between electrode connection 24E and drive electrode 20C.

An electrode (whether a drive electrode 20A-C or a sense electrode 22A-JJJ) may be an area of conductive material forming a shape, such as for example a disc, square, rectangle, other suitable shape, or suitable combination of these. In particular embodiments, the conductive material of an electrode, e.g., 22A and 20C, may occupy approximately 100% of the area of its shape. As an example and not by way of limitation, drive and sense electrodes e.g., 22A and 20C, along with electrode connectors, e.g., 24J, may be made of indium tin oxide (ITO) and the ITO of the drive and sense electrodes, e.g., 22A and 20C, may occupy approximately 100% of the area of its shape, where appropriate. In particular embodiments, the conductive material of an electrode, e.g., 22A and 20C, may occupy approximately 50% of the area of its shape. As an example and not by way of limitation, an electrode, e.g., 22A and 20C, may be made of ITO and the ITO of the drive and sense electrodes, e.g., 22A and 20C, may occupy approximately 50% of the area of its shape in a hatched or other suitable pattern. In particular embodiments, the conductive material of an electrode, e.g., 22A and 20C, may occupy approximately 5% of the area of its shape. As an example and not by way of limitation, an electrode, e.g., 22A and 20C, may be made of fine lines of metal (such as for example copper, silver, or a copper- or silver-based material) or other conductive material and the fine lines of conductive material may occupy approximately 5% of the area of its shape in a hatched or other suitable pattern. Although this disclosure describes or illustrates particular electrodes made of particular conductive material forming particular shapes with particular fills having particular patterns, this disclosure contemplates any suitable electrodes made of any suitable conductive material forming any suitable shapes with any suitable fills having any suitable patterns. Where appropriate, the shapes of the electrodes (or other elements) of a touch sensor may constitute in whole or in part one or more macro-features of the touch sensor. One or more characteristics of the implementation of those shapes (such as, for example, the conductive materials, fills, or patterns within the shapes or the means of electrically isolating or physically separating the shapes from each other) may constitute in whole or in part one or more micro-features of the touch sensor.

In particular embodiments, each drive electrode 20A-C and sense electrode 22A-JJJ includes projections 34A-B from a main electrode portion. Projections 34A of each sense electrode 22A-JJJ may be adjacent to a projection 34B of corresponding drive electrode 20A-C forming capacitive coupling edges separated by a gap 32. Projections 34A-B may be interleaved or interdigitated to increase the number of capacitive coupling edges between one or more sense electrodes and a corresponding drive electrode. As an example and not by way of limitation, projections 34A of sense electrodes 22CCC and 22GGG may be interdigitated with projections 34B of corresponding drive electrode 20C. Capacitive coupling between sense electrode and corresponding drive electrode may be determined by dimensions of gap 32 and edges of projections 34A-B of the electrodes. Although this disclosure describes and illustrates a particular arrangement of electrodes for touch sensor 10, this disclosure contemplates any suitable arrangement of electrodes for touch sensor 10.

Optical properties of gap 32 as well as voids 36 within other areas of the array with large dimensions relative to feature sizes of drive electrodes 20A-C may have different optical properties than the optical properties of electrodes (either sense 22A-JJJ or drive electrodes 20A-C). Optical discontinuities may occur when viewing a display underneath touch sensor 10 due to these differences in optical properties. Gaps 32 and voids 36 within other areas of the array may be substantially filled using the conductive material used to fabricate drive electrodes 20A-C and sense electrodes 22A-JJJ in such a way to electrically isolate the filled in areas from nearby drive electrodes 20A-C and sense electrodes 22A-JJJ or electrode connectors, e.g., 24A, 24J, and 26A. In particular embodiments, gaps 32 and voids 36 may be substantially filled using “in-fill” shapes of electrode conductive material isolated from neighboring in-fill shapes by non-conducting gaps. The isolated in-fill shapes may serve to visually obscure a pattern of drive electrodes 20A-C and sense electrodes 22A-JJJ, while having a minimal impact on the fringing fields between adjacent electrodes. Therefore, using in-fill shapes may have electric field distributions substantially similar to electric field distributions without in-fill shapes. The in-filling may be formed during manufacture and using the same process steps as drive electrodes 20A-C and sense electrodes 22A-JJJ, such that in-fill shapes may be formed from the same material and may have substantially the same thickness and electrical properties as drive electrodes 20A-C and sense electrodes 22A-JJJ.

Filling in gap 32 or void 36 using in-fill shapes may reduce a number of areas with optical discontinuities visible when viewing the display. In particular embodiments, in-fill shapes may be formed using metal, conductive plastic, ITO, or other form of conductive material, such as fine line metal. The material used to fill in a gap 32 or void 36 may depend on the conductive material used to fabricate drive electrodes 20A-C and sense electrodes 22A-JJJ. As an example and not by way of limitation, gaps 32 and voids 36 may be substantially filled in using a series of electrically isolated squares formed during fabrication of drive electrodes 20A-C and sense electrodes 22A-JJJ. Although this disclosure describes or illustrates particular in-fill shapes having particular patterns, this disclosure contemplates any suitable in-fill shapes having any suitable patterns.

Drive electrodes 20A-C and sense electrodes 22A-JJJ may be coupled to tracks, e.g., 14A, 14C, and 14F through electrode connections, e.g., 24A and 24J. In particular embodiments, drive electrodes 20A-C, sense electrodes 22A-JJJ, and electrode connectors, e.g., 24A and 24J, may be formed using a single conductive layer. In other particular embodiments, connections from sense electrodes 22A-JJJ to corresponding tracks, e.g., 14A and 14C, may be determined based on a position relative to axis 38, provided as an illustration and not by way of limitation. As an example and not by way of limitation, sense electrode 22EE may be left of axis 38. On this basis, sense electrode 22EE may be coupled to track 14E on a left side of the array. Similarly, sense electrode 22FF located right of axis 38 and may be coupled to track 14F on a right side of the array. As described above, columns of sense electrodes, such as 22A-AAA, may be commonly coupled to track 14A. In particular embodiments, drive electrodes 20A-C and ground lines 30 may be continuous across the length of the rows of the array. As an example and not by way of limitation, drive electrode 20C may be coupled to a track 14C on either side of the array, while ground connections 30 may be coupled to tracks 14_{Gnd} on both sides of the array. In other particular embodiments, tracks, e.g., 14A and 14C, may be located on a different vertical level than electrode connectors, e.g., 24A and 26A. As described above, the controller transmits drive signals to drive electrodes 20A-C and receives sensing signals from sense electrodes 22A-JJJ through tracks, e.g. 14A, 14C, 14E, and 14F, to determine the position of the object adjacent touch sensor 10.

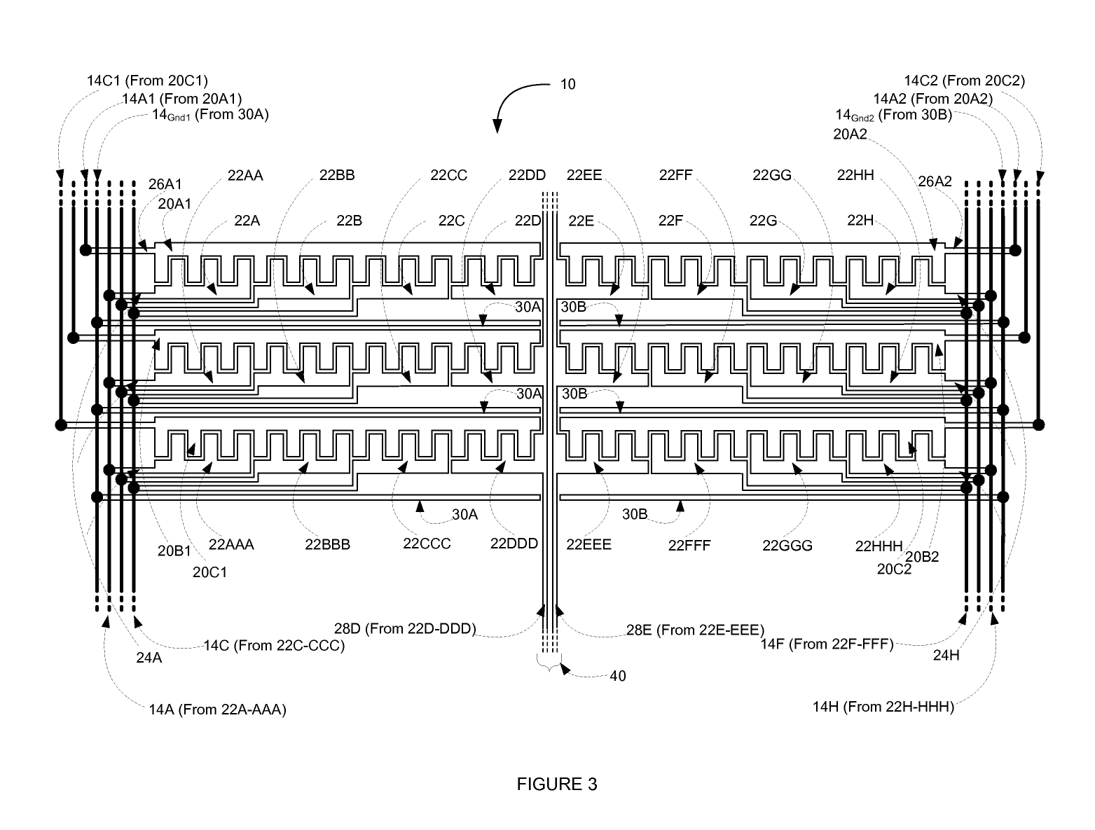

FIG. 3 illustrates an example single-layer touch sensor with a central spine for use in the example system of FIG. 1. In the example of FIG. 3, a central spine 40, including electrode connectors 28D-E, extends continuously across the touch sensitive area of touch sensor 10 and notionally divides the touch-sensitive area of touch sensor 10 into halves. Corresponding sense electrodes 22D-DDD and 22E-EEE on either side of central spine 40 may be commonly coupled to electrode connectors 28D and 28E, respectively. As an example and not by way of limitation, columns of sense electrodes, 22A-AAA and 22C-CCC, left of central spine 40 may be commonly coupled to tracks, 14A and 14E, respectively, located on a left side of the array. Similarly, columns of sense electrodes, 22F-FFF and 22H-HHH, right of central spine 40 may be commonly coupled to tracks, 14F and 14H, respectively, located on a right side of the array. As described above, one or more sense electrodes, e.g., 22A-AAA, commonly coupled to a track, e.g., 14A, may define columns that are substantially perpendicular to rows of the array.

In particular embodiments, drive electrodes 20A1-2, B1-2, and C1-2 may be continuous from a side of the array to central spine 40. As with sense electrodes 22A-HHH, drive electrodes 20A1-2, B1-2, and C1-2 may be coupled to tracks, e.g. 14A2 and 14C1, according to a position of drive electrodes 20A1-2, B 1-2, and C1-2 relative to central spine 40. As an example and not by way of limitation, drive electrode 20A1 may be coupled to track 14A1 on a left side of the array through electrode connector 26A1. Also, drive electrode 20A2 may be coupled to track 14A2 located on the right side of the array through electrode connector 26A2. In particular embodiments, tracks 14A1-2 coupled to a row of drive electrodes 20A1-2 may be coupled together with a connection (not shown) outside the touch-sensitive area of touch sensor 10.

Similarly, in particular embodiments, ground shape 30A-B may be continuous from a side of the array to central spine 40. Ground shape 30A-B may be coupled to tracks, e.g. 14_{Gnd1} and 14_{Gnd2}, according to a position of ground shape 30A-B relative to central spine 40. As an example and not by way of limitation, ground shape 30A may be coupled to track 14_{Gnd1} on the left side of the array and ground shape 30B may be coupled to track 14_{Gnd2} located on the right side of the array. In particular embodiments, ground shape 30A-B may be coupled together with a wrap-around (not shown) connection outside the touch-sensitive area of touch sensor 10.

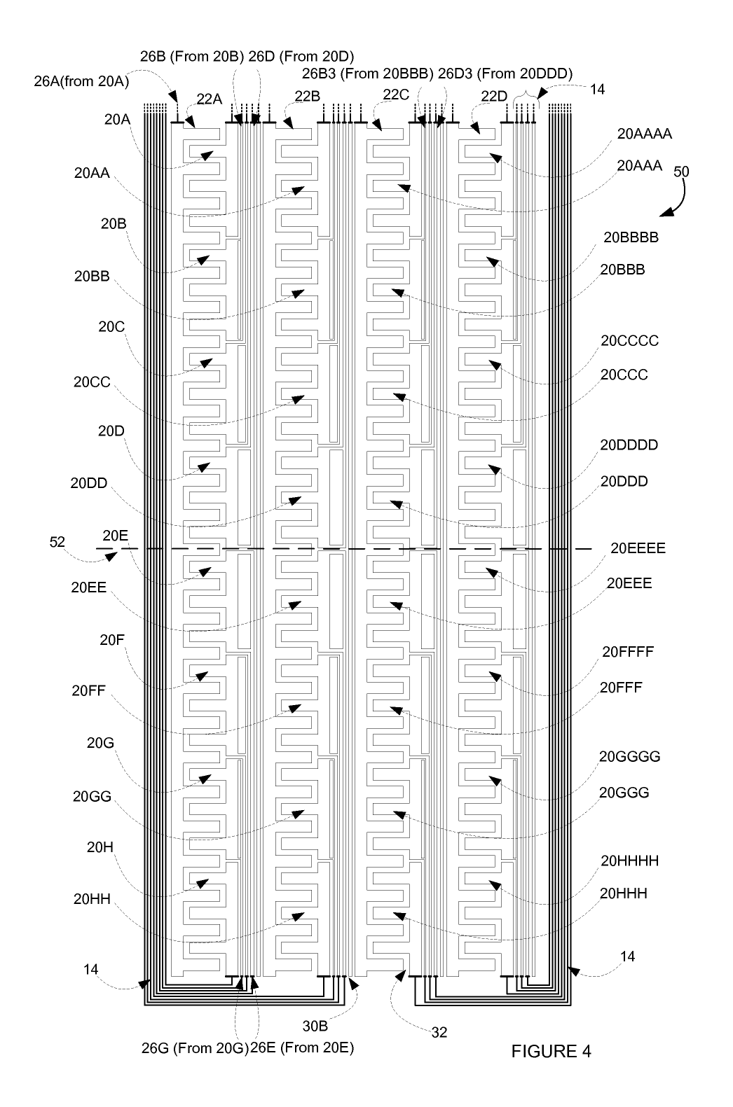

FIG. 4 illustrates an example single-layer touch sensor with a rotated array of electrodes for use in the example system of FIG. 1. In the example of FIG. 4, touch sensor 50 may have a pattern of electrodes that may be a rotated 90° in comparison with the touch sensor 10 of FIG. 2, such that the operation of the drive electrodes 20A-HHHH and sense electrodes 22A-D may be reversed. In other words, sense electrodes 22A-D of touch sensor 50 may be continuous along an axis corresponding to a column of the array having projections of drive electrodes 20A-HHHH interleaved with projections of each corresponding sense electrodes 22A-D. Touch sensor 10 additionally includes ground shape, e.g., 30B, extending the length of each column and substantially suppresses unintentional capacitive coupling between drive electrodes of one column from sense electrodes of another column. As an example and not by way of limitation, ground shape 30B substantially suppresses unintentional capacitive coupling between drive electrode connectors and sense electrode 22C.

Drive electrodes 20A-HHHH of the array may be coupled to tracks 14 through electrode connections. As an example and by not way of limitation, electrode connections 26B and 26D3 may couple drive electrodes 20B and 20DDD, respectively, to corresponding one of tracks 14. In particular embodiments, connections from drive electrodes 20A-HHHH to corresponding tracks 14, may be determined based on a position relative to axis 52, provided as an illustration and not by way of limitation. As an example and not by way of limitation, drive electrodes 20G and 20E may be coupled to corresponding one of tracks 14 on a bottom side of the array through electrode connection 26G and 26E, respectively. Drive electrodes 20BBB and 20DDD may be coupled to corresponding one of tracks 14 located on the top side of the array through electrode connections 26B3 and 26D3, respectively. In particular embodiments, electrode connectors, e.g., 26B and 26B3, of drive electrodes, e.g., 20B-BBBB, may be coupled together with a connection (not shown) outside the touch-sensitive area of touch sensor 50 to define rows of the array. In other particular embodiments, electrode connectors with a longer run may be wider than electrode connectors with a shorter run, so as to maintain a substantially constant resistance to drive electrodes 20A-HHHH. As an example and not by way of limitation, electrode connector 26D may be wider than electrode connector 26B.

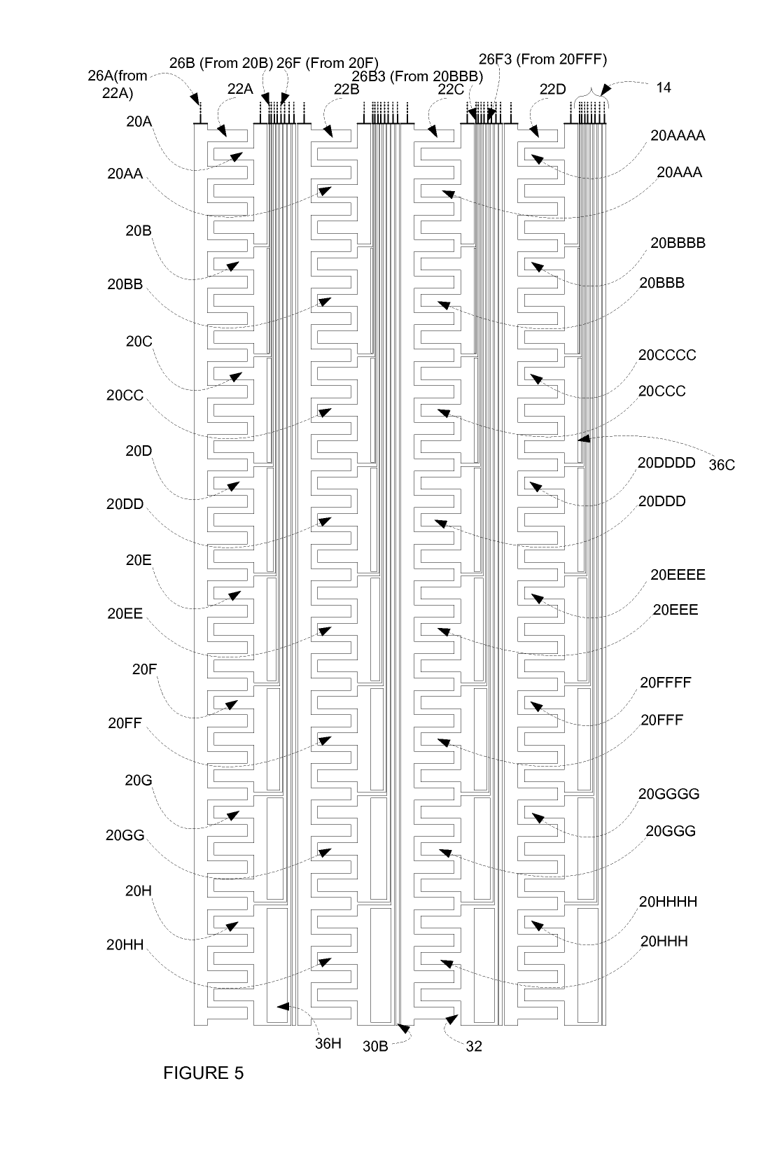

FIG. 5 illustrates an example single-layer touch sensor with a rotated array of electrodes and single-sided track coupling for use in the example system of FIG. 1. In the example of FIG. 5, touch sensor 60 may have a pattern of electrodes where sense electrodes 22A-D may be continuous along an axis corresponding to a column of the array with a plurality of drive electrodes 20A-HHHH interleaved with each corresponding sense electrodes 22A-D. Touch sensor 60 may additionally include ground shape, e.g., 30B, extending the length of each column and substantially suppresses unintentional capacitive coupling between drive electrodes of one column from sense electrodes of another column. As an example and not by way of limitation, ground line 30B substantially suppresses capacitive coupling between drive electrodes 20AA-HH and sense electrode 22C.

Drive electrodes 20A-HHHH of the array may be coupled to tracks 14 through electrode connections. As an example and by not way of limitation, electrode connectors 26B and 26F3 may couple drive electrodes 20B and 20FFF, respectively, to corresponding one of tracks 14. As described above, electrode connectors of drive electrodes may be coupled together with a wrap-around (not shown) connection outside the touch-sensitive area of touch sensor 60 to define rows of the array. In particular embodiments, electrode connectors coupling drive electrodes 20A-HHHH to corresponding tracks 14 may be routed from a top of the array while maintaining substantially the same area or capacitance associated with each drive electrode 20A-HHHH. As an example and not by way of limitation, drive electrode 20H may have substantially the same area as drive electrode 20CCCC even with fewer electrode connectors being present lower down the array. As described above, gap 32 and voids, e.g., 36C and 36H associated with drive electrodes 20A-HHHH of the array may be substantially filled using the conductive material used to fabricate drive electrodes 20A-HHHH and sense electrodes 22A-D in such a way to electrically isolate the filled in areas from nearby drive electrodes 20A-HHHH and sense electrodes 22A-D or electrode connectors, e.g., 26B and 26F3.

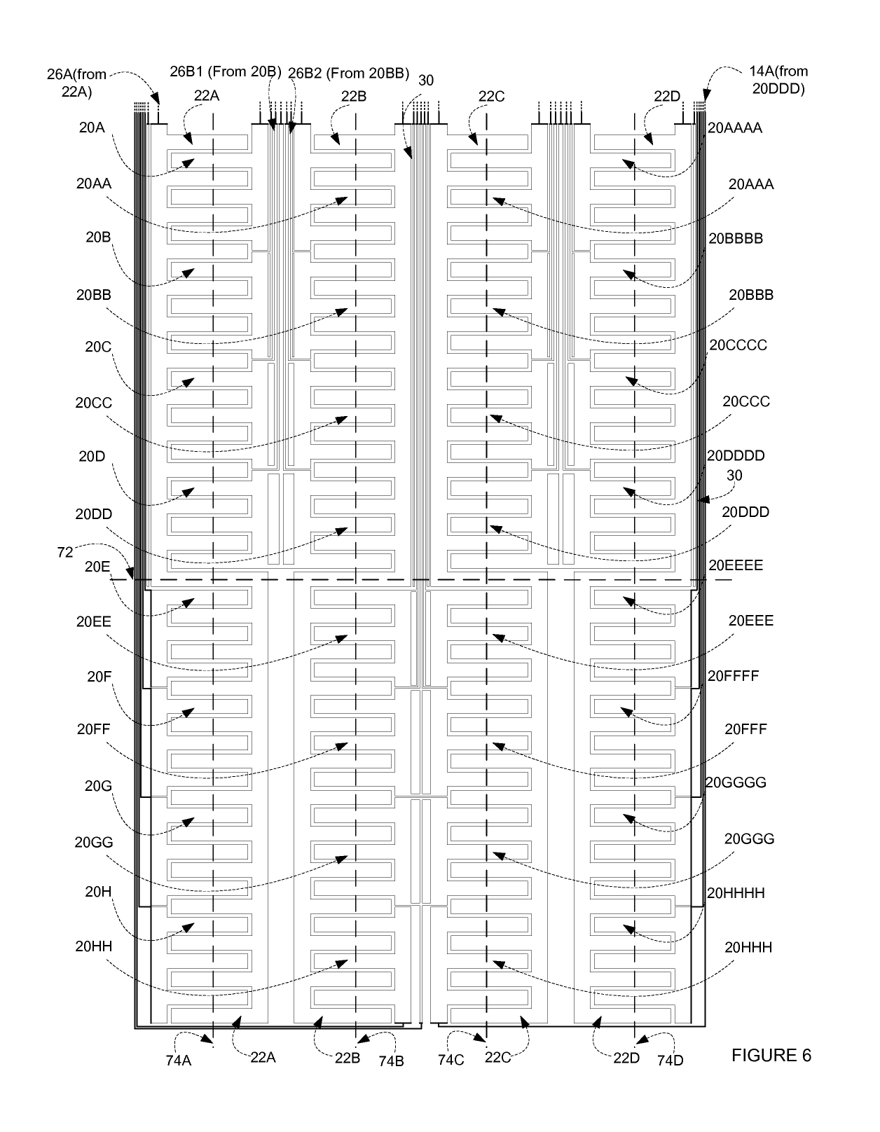

FIG. 6 illustrates an example single-layer touch sensor with a switched-position electrodes for use in the example system of FIG. 1. In the example of FIG. 6, touch sensor 70 may have a pattern of electrodes where sense electrodes 22A-D may be continuous along axes 74A-D notionally dividing each column of touch sensor 70 into halves. In addition, touch-sensitive area of touch sensor 70 may be notionally divided into a top half and bottom half about axis 72. Each sense electrode 22A-D may be routed along one side of axes 74A-D in the touch-sensitive area above axis 72. Below axis 72, each sense electrode 22A-D may be flipped about axes 74A-D, such that each sense electrode 22A-D may be routed on an opposite side relative to axes 74A-D. As an example and not by way of limitation, above axis 72, sense electrode 22A may be routed left of axis 74A. Below axis 72, sense electrode 22A may flipped about and routed right of axis 74A. Above axis 72, corresponding drive electrodes 20A-D may be located right of axes 74A-D and projections of drive electrodes 20A-D interleaved with projections of sense electrode 22A. Below axis 72, corresponding drive electrodes 20E-H may be located left of axes 74A-D and projections of drive electrodes 20E-H interleaved with projections of sense electrode 22A-D.

Drive electrodes 20A-EEEE of the array may be coupled to tracks 14 through electrode connections. As an example and by not way of limitation, electrode connections 26B1 and 26B2 may couple drive electrodes 20B and 20BB, respectively, to corresponding one of tracks 14. In particular embodiments, some electrode connections of drive electrodes 20A-EEEE to corresponding tracks 14, may be routed to a top of the array, while a reminder of drive electrodes 20A-EEEE may be routed to tracks 14 through a bottom of the array. As an example and not by way of limitation, electrode connection 26B2 of drive electrode 20BB may be routed through the top of the array, while sense electrode 22DDD may be coupled to a corresponding track 14A through a bottom of the array. As described above, electrode connectors of drive electrodes may be coupled together with a connection (not shown) outside the touch-sensitive area to define rows of the array.

It should be noted in the switched-position configuration may have drive electrodes 20A-EEEE in one column adjacent to drive electrodes 20A-EEEE of the next column or sense electrodes 20A-D one column adjacent to sense electrodes 20A-D of the next column. As an example and not by way of limitation, drive electrode 20CCC may be adjacent to drive electrode 20CCCC above axis 72, while below axis 72, sense electrode 20A may be adjacent to sense electrode 20B. In other words, for a given column the electrode configuration above axis 72 may be a mirror image of the electrode configuration below axis 72. In particular embodiments, touch sensor 70 may include a ground shape 30 between tracks 14 and sense electrode 22A and 22D along a periphery of the array. In other particular embodiments, touch sensor 70 may include a ground shape 30 between electrode connectors and sense electrodes 22B and 22C within an interior of the array.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A touch sensor comprising:
a plurality of first electrode lines along a first direction, each of the first electrode lines comprising a plurality of first electrodes; and
a plurality of second electrode lines along a second direction that is substantially perpendicular to the first direction, each of the second electrode lines comprising one second electrode, the one second electrode of each of the second electrode lines being interdigitated with one of the first electrodes of each of the first electrode lines, the first and second electrodes being disposed on one side of a substrate.

2. The touch sensor of claim 1, wherein:
each of the first electrode lines is a sense line of the touch sensor;
each of the first electrodes is a sense electrode of the touch sensor;
each of the second electrode lines is a drive line of the touch sensor; and
each of the second electrodes is a drive electrode of the touch sensor.

3. The touch sensor of claim 1, wherein:
each of the first electrode lines is a drive line of the touch sensor;
each of the first electrodes is a drive electrode of the touch sensor;
each of the second electrode lines is a sense line of the touch sensor; and
each of the second electrodes is a sense electrode of the touch sensor.

4. The touch sensor of claim 1, wherein each of the first and second electrodes comprises an extent along the second direction and one or more projections from its extent along the first direction.

5. The touch sensor of claim 4, wherein the one or more projections of the first electrodes capacitively couple to the one or more projections of the second electrodes.

6. The touch sensor of claim 1, further comprising one or more conductive spines having an extent along the first direction, each of the one or more conductive spines being coupled to the first electrodes of one of the first electrode lines.

7. The touch sensor of claim 1, further comprising a plurality of electrode connectors having an extent along the second direction, each of the electrode connectors coupling one of the first electrodes lines to tracking along one or more edges of the touch sensor.

8. The touch sensor of claim 7, wherein the electrode connectors couple the first electrodes to tracking along an edge of the touch sensor.

9. The touch sensor of claim 1, wherein a first pattern of the first and second electrodes within a first portion of the touch sensor is a mirror image of a second pattern of first and second electrodes within a second portion of the touch sensor.

10. The touch sensor of claim 9, wherein the first portion of the touch sensor is adjacent to the second portion of the touch sensor.

11. A device comprising:
a touch sensor comprising:
a plurality of first electrode lines along a first direction, each of the first electrode lines comprising a plurality of first electrodes; and
a plurality of second electrode lines along a second direction that is substantially perpendicular to the first direction, each of the second electrode lines comprising one second electrode, the one second electrode of each of the second electrode lines being interdigitated with one of the first electrodes of each of the first electrode lines, the first and second electrodes being disposed on one side of a substrate; and
one or more computer-readable non-transitory storage media embodying logic that is configured when executed to control the touch sensor.

12. The device of claim 11, wherein:
each of the first electrode lines is a sense line of the touch sensor;
each of the first electrodes is a sense electrode of the touch sensor;
each of the second electrode lines is a drive line of the touch sensor; and
each of the second electrodes is a drive electrode of the touch sensor.

13. The device of claim 11, wherein:
each of the first electrode lines is a drive line of the touch sensor;
each of the first electrodes is a drive electrode of the touch sensor;
each of the second electrode lines is a sense line of the touch sensor; and
each of the second electrodes is a sense electrode of the touch sensor.

14. The device of claim 11, wherein each of the first and second electrodes comprises an extent along the second direction and one or more projections from its extent along the first direction.

15. The device of claim 14, wherein the one or more projections of the first electrodes capacitively couple to the one or more projections of the second electrodes.

16. The device of claim 11, wherein the touch sensor further comprising one or more conductive spines having an extent along the first direction, each of the one or more conductive spines being coupled to the first electrodes of one of the first electrode lines.

17. The device of claim 11, further comprising a plurality of electrode connectors having an extent along the second direction, each of the electrode connectors coupling one of the first electrodes lines to tracking along one or more edges of the touch sensor.

18. The device of claim 11, wherein a first pattern of the first and second electrodes within a first portion of the touch sensor is a mirror image of a second pattern of the first and second electrodes within a second portion of the touch sensor.

19. The device of claim 18, wherein the first portion of the touch sensor is adjacent to the second portion of the touch sensor.

20. The device of claim 11, wherein the device is one or more of a desktop computer, a laptop computer, a tablet computer, a personal digital assistant (PDA), a smartphone, a satellite navigation device, a portable media player, a portable game console, a kiosk computer, or a point-of-sale device.
